(19) United States
(12) Patent Application Publication
(10) Pub. No.: US 2013/0045016 A1
(43) Pub. Date: Feb. 21, 2013

(54) Signal Recovery System

(71) Applicants: Nicholas John Doran, Straford-Upon-Avon (GB); Olugbenga Olubodun, Birchgrove (GB); Donald Govan, Torquay (GB)

(72) Inventors: Nicholas John Doran, Straford-Upon-Avon (GB); Olugbenga Olubodun, Birchgrove (GB); Donald Govan, Torquay (GB)

(21) Appl. No.: 13/579,210

(22) PCT Filed: Feb. 22, 2011
(86) PCT No.: PCT/GB11/50338

§ 371 Date: Nov. 1, 2012

(30) Foreign Application Priority Data
Feb. 22, 2010 (GB) 1002963.,5

(51) Int. Cl. H04B 10/06

(52) U.S. Cl. 398/214

(57) ABSTRACT

A signal recovery system for a phase modulated signal having a signal spectrum, wherein the phase modulated signal is passed along a communications system (1) having at least one filter (3) so as to define the frequency channel of the communication system. Losses result from the passage of the signal through the at least one filter (3) defining the transmission channel. The signal recovery system recovers at least some of the losses by introducing a relative frequency offset between the signal spectrum and the transmission spectrum of the at least one filter (3) in the communications system.

### CROSS-REFERENCE TO RELATED APPLICATIONS

This application claims priority from PCT/GB/2011/050338 filed on Feb. 22, 2011 and from GB 1002963.5, filed Feb. 22, 2010, which are hereby incorporated by reference in their entireties.

### BACKGROUND OF THE INVENTION

1. Field

The present invention relates to a signal recovery system. In particular but not exclusively, the system is for phase modulated signals which are passed along a filtered channel of a communication system.

2. Related Art

Dense Wavelength Division Multiplexing (DWDM) is a technology that enables data from different sources to be transported along a single optical fibre, whereby each signal is carried substantially simultaneously along its own separate light wavelength. It is feasible that more than 80 separate wavelengths (or channels) of data can be multiplexed into a light-stream transmitted on a single optical fibre, therefore a high number of bits can be delivered per second by the optical fibre.

When considering DWDM systems one of the key considerations is the spectral efficiency of the system which is defined as the ratio of bit rate (b/s) to spectral width (GHz) occupied by the signal. Further, consideration must be given to how closely the channels carrying the data can be spaced. In optical systems it is standard to use a channel spacing defined by the ITU grid, which in the UK is typically 50 GHz.

DWDM systems generally comprise a number of narrow band pass filters to separate the signal into the frequency channels, or to perform other necessary transmission techniques. These may be positioned at the transmitter and receiver end of the DWDM system, or additionally at multiple nodes within the system. These filters are a potential source of penalties in the signal as they remove part of the spectrum. Misalignment of the central frequency of an optical band pass filter is one contributor to signal degradation, so care is generally taken to align the centre frequency of the filter bandwidth so as to minimise this loss contribution.

The data that passes along the communication means may be subjected to a selection of digital modulation schemes, each having advantages and disadvantages associated with them. For example phase shift-keying (PSK) is a digital modulation scheme that conveys data by means of the phase of a carrier wave, whereby the phase of the signal is changed in response to a data signal either by viewing the phase itself as conveying information (the coherent scheme) or by viewing the change in phase as conveying information (the differential scheme).

In the case of the coherent scheme the demodulator must have a reference signal to compare the received signals phase against. In the case of the differential scheme the signal is split and then recombined so as to form destructive and constructive interference fringes. Phase shift keying modulation formats such as Differential Phase Shift Keying (DPSK) and Coherent Phase Shift Keying (CPSK) may be deployed for 40 Gbps and above. Patent application number 08736975.7 describes a system that uses Differential Phase Shift Keying (DPSK) for improving the dispersion tolerance at the receiver. The DPSK demodulator is shown in FIG. 1.

The advantage of phase modulated formats is that there is an improved Optical Signal to Noise Ratio (OSNR) performance over On-Off Keying (OOK) in the binary form and that multilevel versions allow higher data transmission without increasing symbol rates. However, a disadvantage of the known art is that binary phase shift keying (whether it be DPSK or CPSK) suffers a substantial filter penalty at 40 Gbps with a standard 50 GHz spacing. Therefore, higher order modulation formats are used for channels modulated at 40 Gbps and more in a typical 50 GHz channel spaced system. These higher order modulation formats include Differential Quadrature Phase Shift Keying (DQPSK). Such modulation schemes are more costly, complicated to implement and can have further drawbacks (for example reduced signal to noise ratio performance).

### SUMMARY OF THE INVENTION

The present invention seeks to provide a signal recovery system for a tightly filtered communication system that can be applied to a range of phase modulated formats so as to, in particular, decrease the filter penalty. In particular the invention is aimed at a system which includes for example, a 40 Gbps DPSK and CPSK channel in a 50 GHz channel spaced system so as to make this a practical alternative to higher order modulation formats e.g. DQPSK. It should be noted that the invention is not restricted to this data rate and is quite general. For example a 50 Gbps PSK could provide a total of 100 Gbps with polarisation multiplexing.

In conclusion, the invention provides an efficient signal recovery system that can be used in providing efficient communication systems that have to cope with the 60% per annum growth in bandwidth demand and is expected to be the central technology in the all-optical networks of the future.

In a first aspect the present invention provides a signal recovery system for a phase modulated signal, said phase modulated signal being passed along a communications system including at least one filter, the signal recovery system comprising:
a demodulator; and
a frequency offset means configured to provide a relative frequency offset between a signal spectrum associated with the phase modulated signal and a transmission spectrum associated with the at least one filter. The offset provides recovery of signal in a filtered communications system, especially for tightly/narrowly filtered communications systems.

Preferably, the at least one filter is a band pass filter having a predetermined bandwidth so as to define a channel bandwidth of the communications system.

In a preferred embodiment the signal spectrum has a first centre frequency associated with it and the transmission spectrum has a second centre frequency associated with it and the centre frequency of the signal spectrum defines a first offset origin and the relative frequency offset between the signal spectrum and the transmission spectrum is provided by offsetting the centre frequency of the transmission spectrum from the first offset origin. Alternatively, the centre frequency of the transmission spectrum defines a second offset origin and the relative frequency offset between the signal spectrum and the transmission spectrum is provided by offsetting the centre frequency of the signal spectrum from the second offset origin.

Beneficially the phase modulation format is phase shift keying and the demodulator includes a local oscillator. Preferably, the magnitude of the relative frequency offset between the signal spectrum and the transmission spectrum is approximately between 40-60% of the bandwidth of the at least one filter or alternatively the magnitude of the relative frequency offset between the signal spectrum and the transmission spectrum is 50% of the bandwidth of the at least one filter.

In an alternative embodiment the phase modulation format is Differential Phase shift keying and the magnitude of the relative frequency offset between the signal spectrum and the transmission spectrum is approximately between 15% to 85% of the bandwidth of the at least one filter. Where the modulation format is differential phase shift keying is the demodulator converts phase information from the signal into intensity information by causing the data symbols in the signal to interfere by overlapping in time. Preferably, the means for converting phase information from the signal into intensity information is an interferometer having a constructive and/or destructive port.

Beneficially, to form the two filter arrangement at least one offset filter device is positioned at the destructive port of the interferometer or alternatively at least one offset filter is positioned at the constructive port of the interferometer. This improves the signal recovery and requires less of an offset to be applied between the signal spectrum and the filter transmission spectrum.

In a further embodiment at least a first band pass filter and a second band pass filter are arranged in the communications system (positioned in the path of the signal) and the combination of the transmission spectrum of the first band pass filter and the transmission spectrum of the second band pass filter provides a net transmission spectrum having a net bandwidth which defines the channel bandwidth of the communications system. The signal spectrum has a first centre frequency associated with it and the net transmission spectrum has a second centre frequency associated with it. Beneficially, the centre frequency of the signal spectrum defines a first offset origin and the relative frequency offset between the signal spectrum and the net transmission spectrum is provided by offsetting the centre frequency of the net transmission spectrum from the first offset origin or alternatively, the centre frequency of the net transmission spectrum defines a second offset origin and the relative frequency offset between the signal spectrum and the net transmission spectrum is provided by offsetting the centre frequency of the signal spectrum from the second offset origin.

In this further embodiment, the phase modulation format is phase shift keying and the demodulator includes a local oscillator. Beneficially, the magnitude of the relative frequency offset between the signal spectrum and the net transmission spectrum is approximately between 40-60% of the net bandwidth of the at least first filter and second filter or alternatively, the magnitude of the relative frequency offset between the signal spectrum and the net transmission spectrum is 50% of the net bandwidth of the at least first filter and second filter.

In an alternative embodiment, the phase modulation format is Differential Phase shift keying, wherein the magnitude of the relative frequency offset between the signal spectrum and the net transmission spectrum is approximately between 15% to 85% of the net bandwidth of the at least first filter and second filter. Beneficially, the demodulator converts phase information from the signal into intensity information by causing the data symbols in the signal to interfere by overlapping in time and the means for converting phase information from the signal into intensity information is an interferometer having a constructive and/or destructive port.

Beneficially, to form the two filter arrangement at least one offset filter device is positioned at the destructive port of the interferometer or alternatively at least one offset filter is positioned at the constructive port of the interferometer.

Preferably the frequency offset means is a tuneable laser, or alternatively the frequency offset means is at least one offset filter positioned in the transmission path before the demodulator, or alternatively at least one offset filter is positioned at the destructive port of the interferometer and at the constructive port of the interferometer.

In accordance with a further embodiment of the invention there is provided a communications system for the communication of a phase modulated signal, said communications system comprising:
at least one filter;
a demodulator; and
a frequency offset means configured to provide a relative frequency offset between a signal spectrum associated with the phase modulated signal and a transmission spectrum associated with the at least one filter.

In an alternative embodiment there is provided a communications system for the communication of a phase modulated signal, said communications system comprising:
at least a first filter and a second filter;

a demodulator; and
a frequency offset means configured to provide a relative frequency offset between a signal spectrum associated with the phase modulated signal and a net transmission spectrum associated with the at least first filter and second filter.

In accordance with a further embodiment of the invention, there is provided a signal recovery method for a phase modulated signal, said phase modulated signal being passed along a communications system including at least one filter, the method comprising:
applying a relative frequency offset between a signal spectrum associated with the phase modulated signal and a transmission spectrum associated with the at least one filter; and
demodulating the phase modulated signal.

Preferably, the frequency bandwidth of the at least one filter is used to define a channel bandwidth of the communications system.

Beneficially, the signal spectrum has a centre frequency associated with it and the transmission spectrum has a second centre frequency associated with it. In a preferred embodiment the centre frequency of the signal spectrum defines a first offset origin and the centre frequency of the transmission spectrum is offset from the first offset origin and in an alternative embodiment the centre frequency of the transmission spectrum defines a second offset origin and the centre frequency of the signal spectrum is offset from the second offset origin.

Beneficially the modulation format is phase shift keying and the modulated signal is demodulated by combining the modulated signal with a local oscillator. Preferably, the magnitude of the relative frequency offset between the signal spectrum and the transmission spectrum is approximately between 40% to 60% of the frequency bandwidth of the at least one filter or alternatively the magnitude of the relative frequency offset between the signal spectrum and the transmission spectrum is approximately 50% of the frequency bandwidth of the at least one filter.

Alternatively, the modulation format is Differential phase shift keying preferably wherein the magnitude of the relative frequency offset between the signal spectrum and the transmission spectrum is approximately between 15% to 85% of the frequency bandwidth of the at least one filter.

Beneficially, the differential phase modulated signal is demodulated by a differential demodulator so as to provide destructive fringes at the destructive port of the differential demodulator and constructive fringes at the constructive port of the differential demodulator. In an alternative embodiment a filter with a frequency offset filter is applied at the destructive port of the differential demodulator a filter with a frequency offset filter is applied at the constructive port of the differential demodulator.

In a further embodiment according to the present invention, the at least a first band pass filter and a second band pass filter are arranged in the communications system and the combination of the transmission spectrum of the first band pass filter and the transmission spectrum of the second band pass filter provides a net transmission spectrum having a net bandwidth which defines the channel bandwidth of the communications system.

In alternative embodiment of the present invention, there is provided a method for processing a phase modulated signal comprising:
passing the phase modulated signal along a communications system including at least one filter;
applying a relative frequency offset between a signal spectrum associated with the phase modulated signal and a transmission spectrum associated with the at least one filter; and
demodulating the phase modulated signal.

In an alternative embodiment of the present invention, there is provided a method for processing a phase modulated signal comprising:
passing the phase modulated signal along a communications system including at least a first filter and second filter;
applying a relative frequency offset between a signal spectrum associated with the phase modulated signal and a net transmission spectrum associated with the at least first filter and second filter; and
demodulating the phase modulated signal.

Importantly for phase modulated signals the provision of a frequency offset between the signal spectrum and the transmission spectrum (or net transmission spectrum) of the filters encountered in the system enables improved signal recovery in a filtered communications system. This is a surprising effect since the inclusion of a small frequency offset between the signal spectrum and the filter transmission spectrum is generally considered to be undesirable and a potential source of losses in the system, so there would be no motivation to introduce a larger frequency offset between the signal spectrum and the filter transmission spectrum (or net transmission spectrum). These and other aspects of the invention will be apparent from, and elucidated with reference to, the embodiment as described herein.

Exemplary embodiments of the invention will now be described with reference to the accompanying figures.

### BRIEF DESCRIPTION OF THE DRAWINGS

FIG. 1 illustrates a known DPSK demodulator;

FIG. 2 illustrates a signal recovery system according to an embodiment of the invention;

FIG. 3 illustrates a signal recovery system according to a further embodiment the invention;

FIG. 4 illustrates a signal recovery system according to another embodiment of the invention;

FIG. 5 illustrates a Differential PSK experimental arrangement for simulating the spectral offset provided by the invention;

FIG. 6 shows a contour plot of Q value, where the x-axis represents the spectral offset of the first filter at the constructive port and the y-axis represents the spectral offset of the second filter at the deconstructive port.

FIG. 7 shows a plot of Q-value against frequency offset rate where the first filter and second filter are matched;

FIG. 8 illustrates a 2 filter differential PSK experimental arrangement including a tunable laser for investigating the effect of the spectral offset provided by the invention;

FIG. 9 shows a contour plot of Q-value, where the x-axis represents the spectral offset of the filter positioned at the destructive port of the demodulator and the y-axis represents the spectral offset of the pre-modulator filter.

FIG. 10 shows a plot of Q value against optical signal to noise ratio; the data being obtained with the 2 filter differential PSK experimental arrangement and the standard offset filtering arrangement;

FIG. 11 illustrates a coherent PSK experimental arrangement for investigating the effect of the spectral offset provided by the invention;

FIG. 12 shows a plot of Q value against the optical signal to noise ratio for the coherent PSK experimental arrangement;

FIG. 13 shows a plot of Q-Value against frequency offset for the differential PSK experimental arrangement;

FIG. 14 shows a plot of Q-Value against frequency offset for the coherent PSK experimental arrangement.

### DETAILED DESCRIPTION OF THE PREFERRED EMBODIMENTS

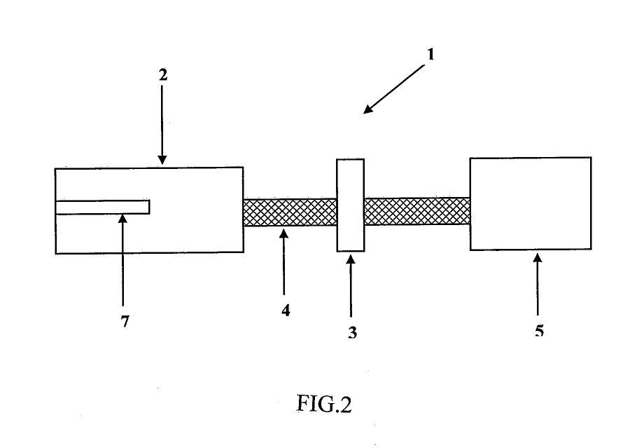

FIG. 2 illustrates a communication system 1 according a first embodiment of the invention. A transmitter 2 provides an optical phase modulated signal comprising a carrier wave in which data symbols are encoded. The carrier wave is provided by an optical laser 7 located at the transmitter 2.

Phase modulation can take the form of the coherent or differential scheme. In both the coherent and differential phase modulation schemes, the carrier wave of the optical phase modulated signal has a signal spectrum (which is generally symmetric), having a bandwidth and a first centre frequency associated with it. The optical phase modulated signal is passed along a signal transporting means 4 to a receiver 5 including a demodulator 52. FIG. 2 shows the signal transporting means to be an optical fibre. A standard optical fibre 4 includes in-line filter devices used to define the channel bandwidth through which the optical phase modulated signal passes. A single filter may define the channel, or multiple filters could be implemented to define the channel. A filter has a spectral response i.e. it has a transmitivity which depends on frequency. Thus the filter also has a spectrum associated with it in the form of a transmission spectrum, which has a second bandwidth and a centre frequency associated with it. This scenario provides two spectra—the first associated with the signal (radiation) itself and the second associated with the transmission of the filter.

The in-line filter devices 3 are optical band pass filter devices having by way of example, a bandwidth of around 35 GHz, therefore causing narrow filtering of the optical phase modulated signal assumed in this example to be 40 Gbps. The concatenation of several in-line filter devices in the optical fibre results in a net-filtering effect, which represents the manifestation of the add/drop nodes in the path of the optical phase modulated signal. The in-line filter devices are represented by a single in-line filter 3 in FIG. 2. The resultant net filtering effect of the in-line filter devices provides a net transmission spectrum.

To provide the optimum passage of the optical phase modulated signal through the filter, it is considered necessary to align the centre frequency of the optical phase modulated signal with the centre frequency of the net transmission spectrum of the in-line filters 3 (providing a zero offset alignment between the first frequency spectrum and the second frequency spectrum). This alignment ensures optimum passage of the optical phase modulated signal at frequencies within the bandwidth of the optical in-line filters 3. This arrangement is usually applied in communication systems or other optical transmission systems since recovering the maximum amount of the signal optimises the signal-to-noise ratio associated with an optical system.

In the invention of FIG. 2, there is provided a relative frequency offset between the signal spectrum (associated with the optical signal) and the net transmission spectrum (associated with the net filtering effect of the in-line filters 3). In the case where only a single filter is positioned in the transmission path of the signal a relative frequency offset between the signal spectrum and the transmission spectrum of the filter is provided. The offset is applied to the entire signal i.e. the relative detuning of the signal spectrum and the transmission spectrum applies to each frequency in the band.

The in-line optical band-pass filters used to define the separate channels of a standard communication system are generally regarded as fixed and therefore it is not usually practicable to offset the centre frequency of the transmission spectrum of the in-line filters from the centre carrier frequency of the spectrum of the optical signal so as to cause the transmission spectrum to be offset from the signal spectrum.

However, since it is a relative offset between the centre frequency of the signal spectrum and transmission spectrum that is required, offsetting the centre frequency of the optical signal with respect to the centre frequency of the net transmission spectrum of the in-line filters is equivalent to offsetting the centre frequency of the net transmission spectrum of the in-line filters to the centre frequency of the signal spectrum. This is because the effect of detuning the laser wavelength and the net filtering effect of the in-line filters 3, which provides the net transmission spectrum, both operate in the linear regime.

Therefore, it is more feasible to provide the relative offset between the signal spectrum and the transmission spectrum by detuning the laser 7 at the transmitter 2 i.e. varying the wavelength of the carrier wave emitted from the laser so as to provide a relative offset between the centre frequency of the carrier wave of the optical signal (the signal spectrum) and the centre frequency of the net filtering effect of the in-line filters 3 of the communication system (the net transmission spectrum). In a first embodiment, displayed in FIG. 2, the relative frequency offset is achieved by using a tunable laser 7 as the source of the carrier wave. The centre frequency of the transmission spectrum is defined as the offset origin since it is a fixed reference point, and the relative offset is provided by offsetting the centre frequency of the signal spectrum from the offset origin.

Detuning the source laser 7 from the centre frequency of the net transmission of the in-line filters 3 in its path would be expected to cause significant penalties, and this is indeed what is observed with a small detuning of the laser 7, however when the detuning is such that a significant portion of the spectrum is removed a large improvement in performance is observed, compared to the performance of a non-detuned system.

The in-line filters in the optical fibre are known to degrade the signal since the narrow frequency bandwidth associated with the in-line filters block frequencies that fall outside of the frequency band-pass. The narrower the bandwidth of the frequency band-pass filter, the higher the percentage of optical phase modulated signal that is prevented from passing through the in-line filter. Introducing the relative offset between the signal spectrum and the transmission spectrum enables the recovery of at least part of the optical phase modulated signal that has been removed. Therefore, the penalty caused by significantly offsetting the centre frequency of the optical signal from the centre frequency of the net transmission spectrum of the in-line filters 3 can significantly reduce the penalty effect of strong filtering.

It has been determined that significant improvements to the transmitted optical phase modulated signal are achieved by detuning the laser 7 carrier frequency such that the magnitude of the relative frequency offset is approximately between 15% to 85% of the net filtering bandwidth of the in-line filters (i.e. the channel bandwidth), where the net filtering bandwidth of the in-line filters is the net filtering bandwidth of the transmission spectrum of the in-line filters of the communication system. For the DPSK system several ‘optima’ are possible within the range but the DPSK system will show maximum performance for 50% offset of the net filtering bandwidth of the in-line filters. The optimum in a practical system may be affected by cross talk from adjacent channels so may not be at exactly 50% but will be approaching this value.

For a channel bandwidth of 35 GHZ and a 42.7 Gb/s RZ-DPSK system, a relative frequency offset of 17.5 GHz provides significant signal recovery compared to a system exhibiting zero offset.

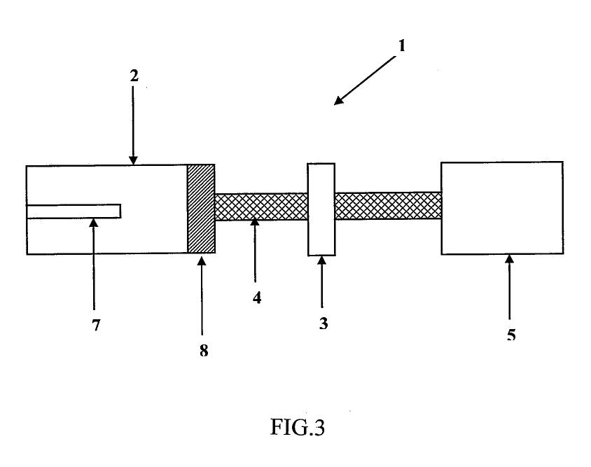

FIG. 3 displays a second embodiment of the invention where the laser 6 of the transmitter 2 is tuned to the offset origin such that the centre frequency of the signal spectrum is aligned with the centre frequency of the transmission spectrum of the in-line filters, which are represented by receiver filter 3a. The receiver filter bandwidth is representative of available bandwidth in a 50 GHz spaced channel. An offset filter device 8 is included in the transmitter 2 such that the frequency offset between the signal spectrum (of the carrier wave) and the transmission spectrum (of the net filtering effect of the in-line filters in the communication system) is provided. In this arrangement the centre frequency of the transmission spectrum is defined as the offset origin. Therefore, the offset filter device 8 is arranged to offset the centre frequency of the signal spectrum from the offset origin. There may also be included means for varying the bandwidth and/or centre frequency of the offset filter device 8.

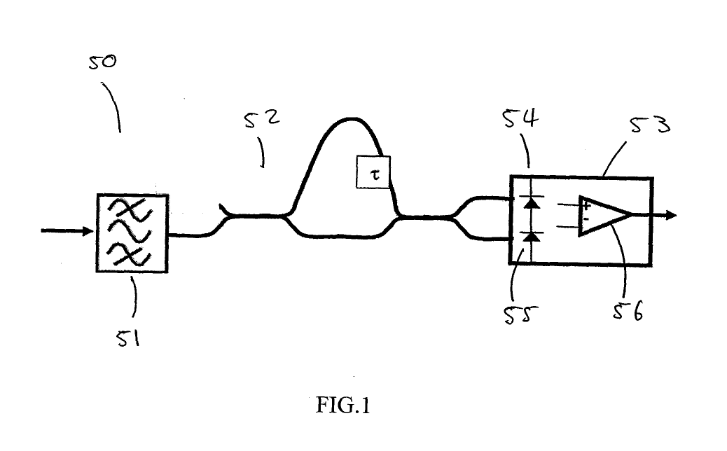

In both embodiment 1 and embodiment 2, the optical signal, which is transported through the optical fibre 4, is passed to the receiver 5. A demodulator is included in the receiver and the form of the demodulator depends on the modulation scheme of the optical phase modulated signal. Where the modulation format is Coherent Phase Shift Keying (CPSK) the demodulator includes a coherent local oscillator, however in the case of Differential Phase Shift Keying (DPSK) any suitable differential demodulator may be used, for example FIG. 1 shows a Mach-Zender interferometer. In the differential scheme the interferometer converts the phase information into intensity information by causing the data symbols in the signal to interfere by overlapping them in time (i.e. the optical signal is split into two signals and recombined). Alternative interferometers may be used in place of the MZI, for example a Michelson interferometer may be implemented.

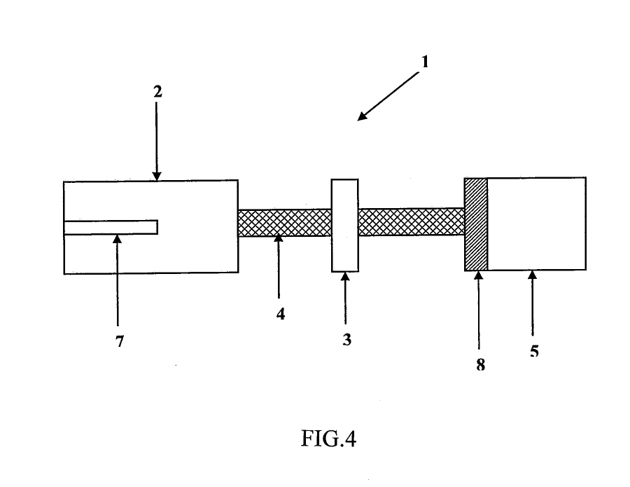

Laser detuning at the transmitter has the same effect as offset filtering at the receiver, therefore in a third embodiment displayed in FIG. 4 there is provided a tuned laser 6 at the transmitter and an offset filter 8 at the receiver end of the communication system. The centre frequency of the carrier wave of the optical phase modulated signal produced by the transmitter 2 (the signal spectrum) is defined as the offset origin. In this embodiment, the in-line filter 3a of the optical fibre is intrinsic to the system since it defines the system channels and these in-line filters are aligned with the offset origin. The relative spectral offset is provided by the receiver filter 8 which is positioned before the MZI, whereby the receiver filter 8 is detuned away from the offset origin.

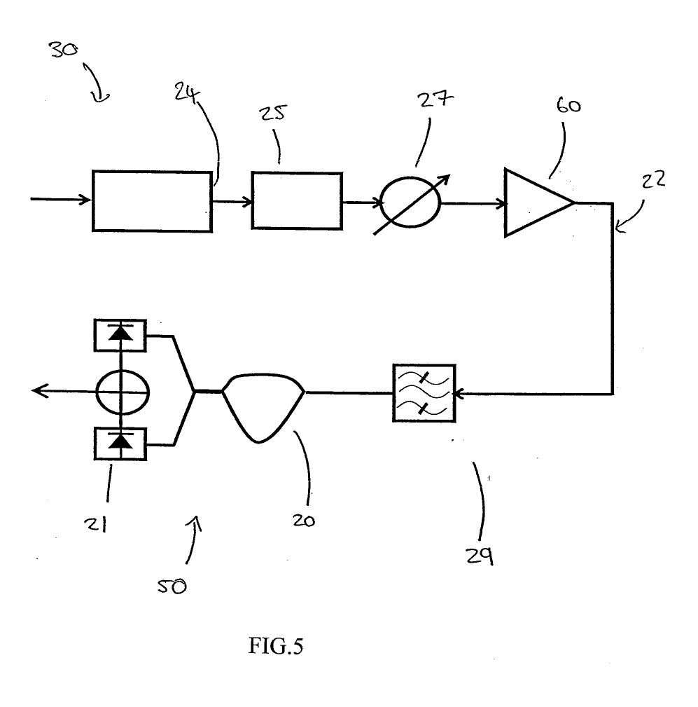

FIG. 5 illustrates schematically a system simulating the effect of the relative spectrum offset provided by the invention whereby the system 1 includes additional features so as to study the effect. For example, the system of FIG. 5 comprises means for adjusting the position of the centre frequency of an offset filter 26 so as to obtain an incremental offset of the centre frequency of the offset filter 26 with respect to the centre frequency of the optical signal (which is aligned with the centre frequency of the receiver filter 29).

In the FIG. 5 arrangement, an incoming data sequence is used to drive a Mach-Zehnder Modulator (MZM) to produce a 42.7 Gbit/s DPSK optical signal, this is followed by a pulse carver MZ-modulator 25 to provide the desired RZ-DPSK duty cycle. The duty cycle may be varied as desired. The default receiver 50 used for comparison contains a Mach-Zehnder Interferometer which implements a 1 bit delay. The object of the arrangement of FIG. 5 is to demonstrate the effects of producing a relative frequency offset between the signal spectrum (associated with the carrier wave of the optical signal) and the transmission spectrum (associated with the in-line filters of the communication system).

The arrangement of the apparatus of FIG. 5 enables several variables of the system to be altered so as to investigate the equivalent effect of varying the centre frequency offset between the centre frequency of the receiver filter device and the centre frequency of the carrier wave. For example the duty cycle, the amount of dispersion in the system and the Signal to Noise Ratio (SNR) can all be varied so as to simulate varying conditions of a standard communication system.

Therefore, the 42.7 GB/s DPSK transmitter of FIG. 5 includes an optical offset band-pass filter 26, arranged to provide an offset between the centre frequency of the offset filter and the centre carrier frequency of the optical signal. It is noted that this is equivalent to providing a relative frequency offset between a signal spectrum associated with the transmitted optical signal and a transmission spectrum associated with the in-line filters of the communication system (or if preferred the signal spectrum could be described as a frequency profile, or spectral density).

The effect of the relative frequency offset between the optical signal and the offset filter has been studied, whereby the offset filter is arranged in-line with the optical signal. In the case where a relative offset was applied, penalty improvements are observed with a balanced detector even when asymmetric losses are present in the receiver path to the balanced photodiodes and/or unequal electrical gains following the diodes.

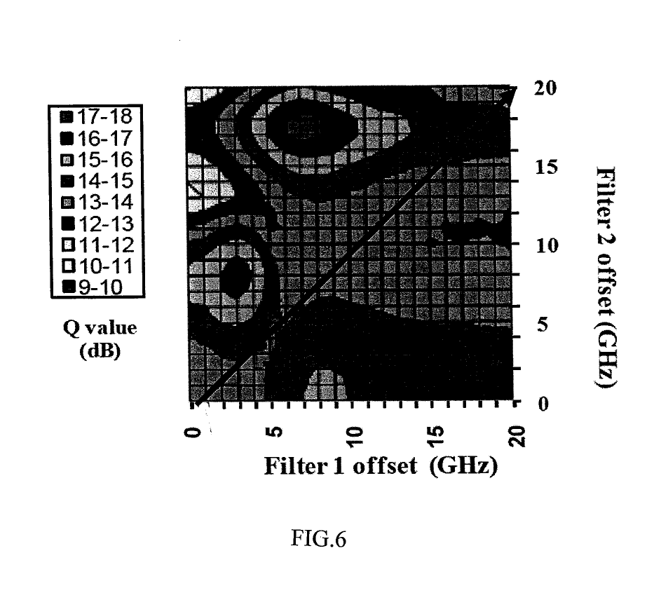

The impact of the different OSNRs on the penalty alleviation of the offset filter was also investigated and the findings are displayed in FIG. 6b. By improving the Q and this the bit error rate, the spectral efficiency of the system is also improved and optical phase modulated signal is recovered

The filter positioned in the signal transmission path before the demodulator (i.e. the pre-modulator filter) may be replaced by a first filter positioned at the constructive port of the MZI and a second filter positioned at the destructive port of the MZI. The frequency offset of the first and second filter must be the same in order to provide the same effect as the pre-demodulator filter. Replacing the filters in this way is valid since providing the frequency offset prior to demodulation is equivalent to providing the same frequency offset at each port after demodulation (provided the frequency offset at each port is equal). The relative frequency offset between the signal spectrum and the transmission spectrum may then be applied by detuning the laser, or by offsetting the frequency of the first filter and the second filter by the same amount. It is also possible for the pre-demodulator filter to be included in combination with the first and second filters so as to provide a net transmission spectrum effect.

The effect of adjusting the frequency offset of the first and second filter was modelled and FIG. 6 displays the contour plot of Q-value for various frequency offsets of the first filter and the second filter (corresponding to the filter positioned at the constructive port and the filter at the destructive port respectively). Regions of improved Q-value can be clearly seen as bulls-eye regions on the contour plot.

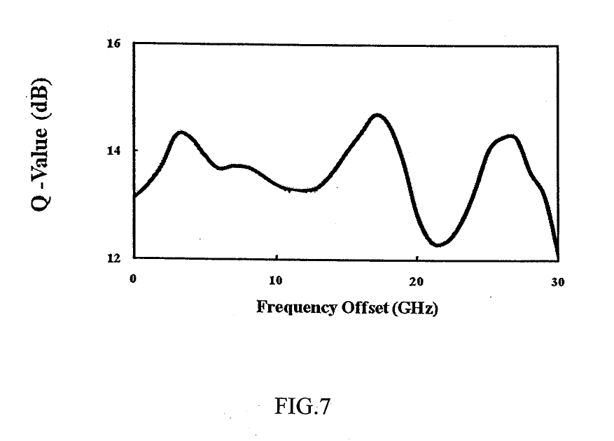

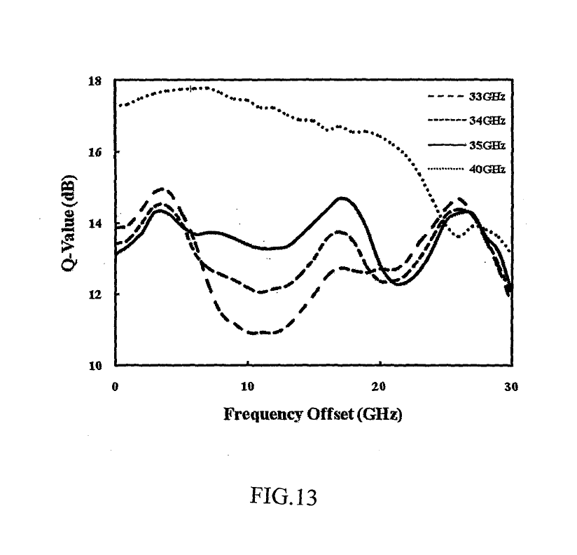

FIG. 7 shows that the Q-value varies when a relative frequency offset is provided between the signal spectrum and a first transmission spectrum (associated with the first filter) and where a second transmission spectrum (associated with the second filter) has also been shifted by the same amount as the first transmission spectrum. This is the balanced DPSK regime (represented by the arrow on FIG. 6) where the frequency offset of the first filter is equal to the frequency offset of the second filter. This plot is equivalent to the 35 GHz case using solely a pre-demodulator filter in FIG. 13.

Referring back to FIG. 6, it is noted that the optimum region of Q-value can be accessed by offsetting the centre frequency of the first filter by around 7 GHz and offsetting the centre frequency of the second filter by around 17 GHz. Therefore, the contour plot implies that an improved Q-value could be possible by introducing an offset at the destructive port that is different to the offset at the constructive port. This information led to the development of the two filter model.

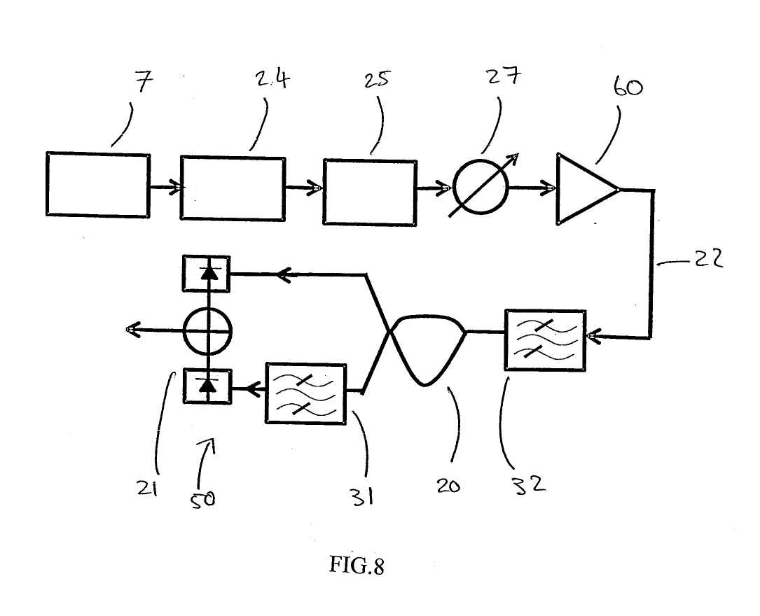

FIG. 8 shows the experimental setup for a two filter model to be used with a DPSK signal. A carrier wave, produced by a tunable transmit laser is passed to a data modulator 24 and then on to a pulse carver 25 so as to create a 42.7 Gbit/s DPSK optical signal. Noise is then added to the signal so as to replicate a real communications system. The signal is then amplified 60 and passed along an optical fibre 22 to a Mach-Zehnder Interferometer (MZI) 20 located in a receiver 50. A first optical band pass filter 32 is positioned in the signal transmission path before the demodulator and represents the narrow filters in a real system which are required to provide the propagation channels in the optical fibre. A second optical band pass filter 31 is arranged at the destructive port of the MZI 20. The bandwidth of the second optical band pass filter 31 is identical with the bandwidth of the first optical band pass filter 32, but need not be so. Both the first filter 32 and the second filter 31 are filtered symmetrically and asymmetrically. There is no filter positioned at the constructive port of the MZI in this embodiment. In the case that a filter is included at the constructive port, no offset is applied or the offset of the filter does not match the offset of the filter at the destructive port. The offset of the first filter is provided by varying the signal output from the tunable transmit laser 7. The second filter 31, which is positioned in the destructive port of the MZI, is a filter with offset.

In this scenario the signal has a signal spectrum; the first filter 32, that represents the net filtering effect of in-line filters, has a first transmission spectrum; and the second filter 31 located in the destructive port of the MZI 20 has a second transmission spectrum.

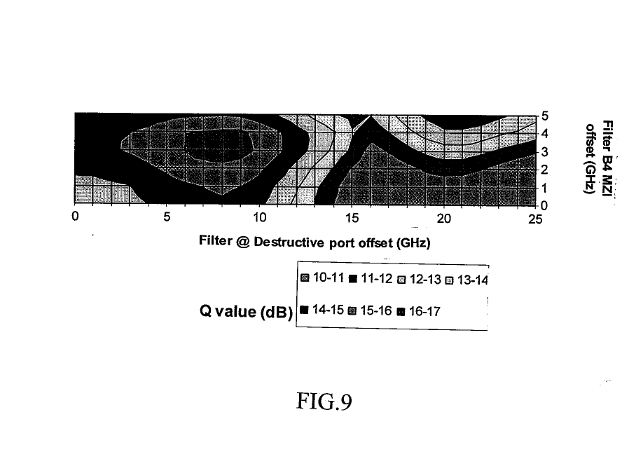

FIG. 9 shows that the optimum Q-value occurs towards the left of the plot at the bulls-eye region. This region can be accessed by offsetting the centre frequency of the first filter 32 by 3-4 GHz and offsetting the centre frequency of the second filter 31 by around 6-8 GHz and provides a Q-value of between 16-17 dB. The precise optima will depend on the details of the system but by having separate detuning, i.e. the first filter (the pre-demodulator filter) can be offset by detuning in the transmit laser, improved performance (i.e. a large improvement in the Q value) can be obtained. The detuning of the laser may be zero or small to provide this improved performance. It is noted that the offset of the filter at the destructive port is around 6-7 GHz, which is less than the frequency offset that suggested in the modelled contour of FIG. 6. This suggests that the inclusion of a filter at the destructive port removes the need for a large relative offset to be applied between the signal spectrum and the first transmission spectrum in order to provide improved performance of the communication system (which results from signal recovery).

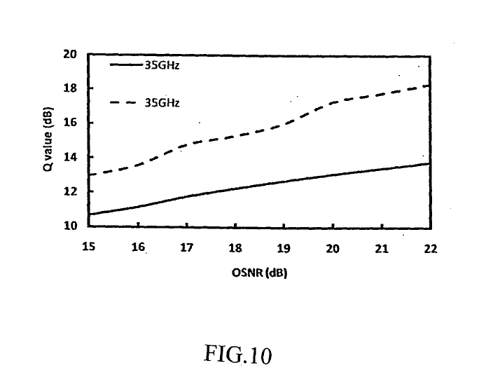

FIG. 10 shows Q-value plotted as a function of optical signal to noise ratio (dB) for a 42.7 Gb/s differential RZ-PSK. The optimum of the two filter model, where a first filter is positioned before the demodulator and second filter is positioned at the destructive port of the MZI, is represented by the dashed line. In this two filter model both the first filter and second filter has a bandwidth of 35 GHz. The continuous line is the optimum result of just offsetting a single filter before the demodulator (which is the same as a filter positioned at the destructive and constructive ports) or equivalently detuning the laser. It is clear that an improvement in Q-factor is obtained by applying the detuning combined with inserting an offset filter at the destructive port of the MZI, and it is reiterated that only a relatively small level of detuning is required to provide this improvement (as demonstrated in FIG. 9).

The relative shifting of the centre frequency of the spectra between the optical source (the laser) with the net transmission spectrum of the inline filters of a real system (or an offset filter at the transmitter, receiver or other position in the optical fibre in a test system) are equally applicable for all phase modulated signals including differential and conventional (coherent).

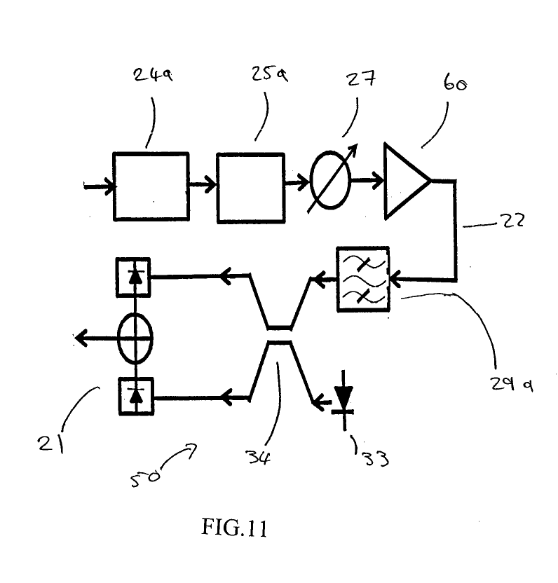

FIG. 11 shows the experimental setup for a coherent PSK system. A carrier wave generated by a laser (not shown) at the transmitter is passed to a signal modulator 24a and then to a pulse carver 25a so as to generate a 42.7 Gb/s PSK coherent optical signal. Noise is then added to the signal so as to replicate a real communications system. The signal is then amplified 60 and passed along an optical fibre 22 which is terminated by a receiver 50. The receiver includes an optical coupler 34 that couples the optical phase modulated signal to a signal provided by an identical optical local oscillator laser 33 (i.e. a laser that is matched in frequency to the transmit laser). A receiver filter 29a, which represents filters in the path of the coherent signal between the transmitter and the receiver is positioned prior to the coupler. The coherent PSK signal defines a signal spectrum and receiver filter 29a, which represents the net effect of the inline filters along the optical fibre, defines a transmission spectrum, both spectra having a centre frequency and a bandwidth. Both the transmit laser and the local laser must be offset by the same amount. The relative frequency offset between the signal spectrum and the transmission spectrum can either be provided by implementing a tunable laser at the transmitter, or by applying a frequency offset filter as the receiver filter 29a and adjusting it as desired.

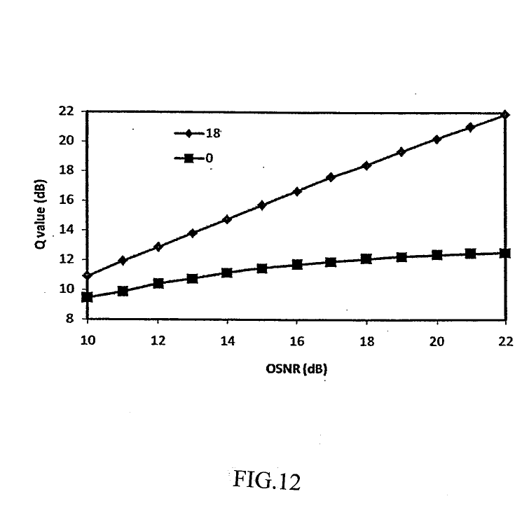

FIG. 12 shows Q value, in dB, plotted as a function of Optical Signal to Noise Ratio (OSNR) in decibels for a 35 GHz optical band pass filter with 42.7 Gb/s coherent PSK. The plot with the square points illustrates the symmetric filtering, with zero offset between the signal spectrum and the transmission spectrum, and the plot with the diamond points illustrates the offset peak of the 35 GHz OBPF, which corresponds to an 18 GHz relative frequency offset between the signal spectrum and the transmission spectrum. It is noted that a significant improvement in the Q factor is obtained when the 18 GHz offset is applied. This coherent detection technique removes the need to use a demodulator of the kind shown in FIG. 1. In a real system the frequency offset can be provided by detuning the source laser or by offsetting a filter located at the receiver, as in the case for the DPSK scheme. It is also envisaged that the offset could be provided at any stage along the optical fibre.

Modifications would be apparent to a person skilled in the art, for example although discussion of the invention has been in respect of 42.7 Gbps signals along a 50 GHz channel, this is merely an example and the technique of applying a relative offset between the frequency spectrum of the carrier wave of an optical phase modulated signal (the signal spectrum) and the transmission spectrum of the at least one filter in the signal path, i.e. offset filtering and the two filter model, are also applicable to other signal transmission speeds and/or channel bandwidths. High channel rate systems are described previously, however offset filtering can be applied to any symbol rate or offset filtering scales. For example neighbouring bandwidths to the 35 GHz bandwidth chosen here may also be implemented in the system, however the exact offset filtering penalty performance of a narrow filtered 42.7 RZ-DPSK system depends on the filter bandwidth, i.e. for a 40 GHz optical band pass filter the peak offset filtering performance is at 7.5 GHz unlike 17.5 GHz for a 35 GHz optical band pass filter as shown in FIG. 13.

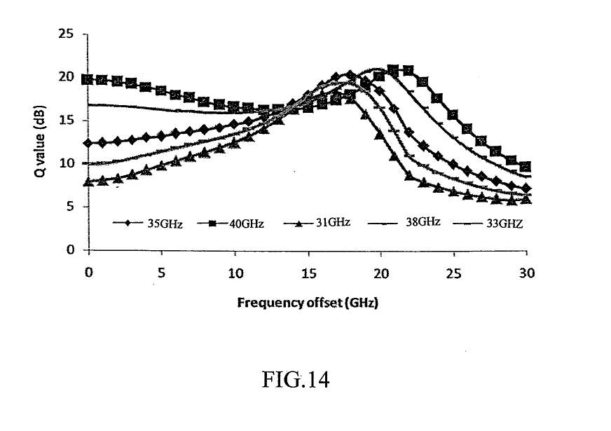

Similarly, FIG. 14 shows a plot of Q value against frequency offset for a variety of filter bandwidths for a narrow filtered 42.7 CPSK. The data is better behaved in the coherent regime, whereby the peak shifts with bandwidth. The inclusion of the relative offset between the signal spectrum and transmission spectrum provides a significant improvement on the resulting signal received by the receiver compared to the zero offset regime. It is also shown that the signal recovery works better for the coherent regime compared to the differential regime where for a 35 GHz band pass filter in the coherent regime the Q factor increases by 7 dB compared to less than 2 dB for the differential scheme. The peak offset filtering performance for a 40 GHz optical band pass filter in the coherent regime is now at around 20 GHz i.e. ½ the filter bandwidth which is in all cases the optimum offset. It is also clearer to see the asymmetric nature of the peak and that the narrower the filter (which is positioned in the transmission path of the optical signal) the greater the recovery. Indeed the performance improves to approach that of a system with no filters positioned in the transmission path of the optical signal i.e. the filter penalty can be almost completely eliminated for a ½ bandwidth offset.

Further, although applying offset filtering is primarily for phase modulated signals it may also be effective for other modulation formats, for example sub-carrier frequency modulation such as OFDM, but excluding amplitude modulation formats. This technique may also provide improved performance for optical superchannels with multiple sub channels with the filtering at the receiver providing the separation.

In the embodiments described previously the signal transporting means 4 that is positioned between the transmitter 2 and the receiver 5 is an optical fibre, however it will be appreciated that a free space version can be implemented.

A further embodiment utilising the configurations of the previous described embodiments may be used in deploying a 6 channel back to back transmission but with a multiplexer and demultiplexer deployed in the transmitter and receiver.

The effects of laser detuning or filter frequency offsetting are not expected to cause any additional penalties in the presence of dispersion and nonlinearity and could even have benefits with nonlinear penalties such as those caused by four wave mixing and cross phase modulation.

The signal recovery system may be applied to a signal that has already been phase modulated and may solely comprise a demodulator and offset filter, the filter either being arranged remote from or integrated with the demodulator. Alternatively, the offset may be provided by a tunable laser, therefore the signal recovery system may solely comprise a tunable laser and a demodulator for use in a standard communications system.

In the two filter arrangement to be used with the DPSK signal, the second filter may be placed at the constructive port, however the best results are obtained when the second filter is placed at the destructive port.

In the case that a receiver offset filter is implemented with the channel filters, the receiver filter is aligned with the channel filters having the same or a similar bandwidth and offset. However, since it is the net frequency offset that produces the desired net transmission profile, it is not critical that the bandwidths of each of the filters are the same or similar and larger differences between the filters may be envisaged.

When considering offset filtering at the receiver in the DPSK scheme, there may be two filters located before the MZI, for example where the centre frequency of the first filter is offset from the offset origin and the centre frequency of the second filter is aligned with the offset origin. Further combinations and further multiples of filters may also be implemented as desired so as to provide the desired frequency offset.

The invention will also apply to higher order phase modulation such as QPSK.

When considering the demodulator, sub-bit delays or coherent receiver and without balanced detection are all also possible.

Advantages include that the system recovers optical phase modulated signal when a relative offset is applied between the frequency spectrum of the carrier wave of a tightly filtered optical phase modulated signal (signal spectrum) and the frequency spectrum of the frequency channel of an optical fibre provided by the inclusion of a single filter or multiple filters (transmission spectrum or net transmission spectrum) so as to provide an improved transmission performance in a communication system. Therefore, transmitting a 40 Gbps optical phase modulated signal (DPSK or CPSK) along a standard 50 GHz spaced optical fibre of a communication system and including the relative frequency offset between the signal spectrum and the transmission spectrum (or net transmission spectrum) offers a more economical and less complicated means to transmit a phase modulated signal along the optical fibre of a standard communications system compared to higher order signal modulation formats. Further, the offset of the frequency spectrum of the carrier wave of an optical signal with respect to at least one filter in the signal path can be applied to all phase modulated formats and other modulation formats, for example sub-carrier frequency modulation such as OFDM.

It should be noted that the above-mentioned embodiment illustrates rather than limits the invention, and those skilled in the art will be capable of designing many alternative embodiments without departing from the scope of the invention as defined by the appended claims. In the claims, any reference signs placed in parentheses shall not be construed as limiting the claims. The word “comprising” and “comprises”, and the like, does not exclude the presence of elements or steps other than those listed in any claim or the specification as a whole. The singular reference of an element does not exclude plural reference of such elements and vice-versa. In a device claim enumerating several means, several of these means may be embodied by one and the same item of hardware. The mere fact that certain measures are recited in mutually different dependent claims does not indicate that a combination of these measures cannot be used to advantage.

1. A signal recovery system for an optical phase modulated signal, said optical phase modulated signal being passed along a communications system including at least one optical filter, the signal recovery system comprising:
a demodulator; and
a frequency offset means configured to provide a relative frequency offset between a signal spectrum associated with the optical phase modulated signal and a transmission spectrum associated with the at least one optical filter.

2. A signal recovery system according to claim 1, wherein the at least one optical filter is an optical band pass filter having a predetermined bandwidth so as to define a channel bandwidth of the communications system.

3. A signal recovery system according to claim 2, wherein the signal spectrum has a first centre frequency associated with it and the transmission spectrum has a second centre frequency associated with it.

4. A signal recovery system according to claim 3, wherein the centre frequency of the signal spectrum defines a first offset origin and the relative frequency offset between the signal spectrum and the transmission spectrum is provided by offsetting the centre frequency of the transmission spectrum from the first offset origin.

5. A signal recovery system according to claim 4, wherein the centre frequency of the transmission spectrum defines a second offset origin and the relative frequency offset between the signal spectrum and the transmission spectrum is provided by offsetting the centre frequency of the signal spectrum from the second offset origin.

6. A signal recovery system according to claim 1, wherein the optical phase modulated signal is modulated with a phase modulation format employing phase shift keying.

7. A signal recovery system according to claim 6, wherein the magnitude of the relative frequency offset between the signal spectrum and the transmission spectrum is approximately between 40-60% of the bandwidth of the at least one optical filter.

8. A signal recovery system according to claim 6, wherein the magnitude of the relative frequency offset between the signal spectrum and the transmission spectrum is 50% of the bandwidth of the at least one optical filter.

9. A signal recovery system according to claim 6, wherein the demodulator includes a local oscillator.

10. A signal recovery system according to claim 1, wherein the optical phase modulated signal is modulated with a phase modulation format employing Differential Phase shift keying.

11. A signal recovery system according to claim 10, wherein the magnitude of the relative frequency offset between the signal spectrum and the transmission spectrum is approximately between 15% to 85% of the bandwidth of the at least one optical filter.

12. A signal recovery system according to claim 10, wherein the demodulator converts phase information from the optical phase modulated signal into intensity information by causing the data symbols in the optical phase modulated signal to interfere by overlapping in time.

13. A signal recovery system according to claim 12, wherein the demodulator is an interferometer having at least one of a constructive and a destructive port.

14. A signal recovery system according to claim 13, wherein the frequency offset means is positioned at the destructive port of the interferometer.

15. A signal recovery system according to claim 13, wherein the frequency offset means is positioned at the constructive port of the interferometer.

16. A signal recovery system according to claim 1, wherein at least a first optical band pass filter and a second optical band pass filter are arranged in the communications system and the combination of the transmission spectrum of the first optical band pass filter and the transmission spectrum of the second optical band pass filter provides a net transmission spectrum having a net bandwidth which defines the channel bandwidth of the communications system.

17. A signal recovery system according to claim 16, wherein the signal spectrum has a first centre frequency associated with it and the net transmission spectrum has a second centre frequency associated with it.

18. A signal recovery system according to claim 17, wherein the centre frequency of the signal spectrum defines a first offset origin and the relative frequency offset between the signal spectrum and the net transmission spectrum is provided by offsetting the centre frequency of the net transmission spectrum from the first offset origin.

19. A signal recovery system according to claim 17, wherein the centre frequency of the net transmission spectrum defines a second offset origin and the relative frequency offset between the signal spectrum and the net transmission spectrum is provided by offsetting the centre frequency of the signal spectrum from the second offset origin.

20. A signal recovery system according to claim 16, wherein the optical phase modulated signal is modulated with a phase modulation format employing phase shift keying.

21. A signal recovery system according to claim 20, wherein the magnitude of the relative frequency offset between the signal spectrum and the net transmission spectrum is approximately between 40-60% of the net bandwidth of the at least first optical band pass filter and second optical band pass filter.

22. A signal recovery system according to claim 20, wherein the magnitude of the relative frequency offset between the signal spectrum and the net transmission spectrum is 50% of the net bandwidth of the at least first optical band pass filter and second optical band pass filter.

23. A signal recovery system according to claim 20, wherein the demodulator includes a local oscillator.

24. A signal recovery system according to claim 16, wherein the optical phase modulated signal is modulated with a phase modulation format employing Differential Phase shift keying.

25. A signal recovery system according to claim 24, wherein the magnitude of the relative frequency offset between the signal spectrum and the net transmission spectrum is approximately between 15% to 85% of the net bandwidth of the at least first optical band pass filter and second optical band pass filter.

26. A signal recovery system according to claim 23, wherein the demodulator converts phase information from the optical phase modulated signal into intensity information by causing the data symbols in the optical phase modulated signal to interfere by overlapping in time.

27. A signal recovery system according to claim 26, wherein the demodulator is an interferometer having at least one of a constructive and a destructive port.

28. A signal recovery system according to claim 27, wherein the frequency offset means is positioned at the destructive port of the interferometer.

29. A signal recovery system according to claim 27, wherein the frequency offset means filter is positioned at the constructive port of the interferometer.

30. A signal recovery system according to claim 1, wherein the frequency offset means is a tuneable laser.

31. A signal recovery system according to claim 1, wherein the frequency offset means is at least one offset filter positioned in the transmission path before the demodulator.

32. A signal recovery system according to claim 1, wherein the frequency offset means is at least one offset filter positioned at the constructive port of the demodulator and positioned at the destructive port of the demodulator.

33. A communications system for the communication of an optical phase modulated signal, said communications system comprising:
at least one optical filter;
a demodulator; and
a frequency offset means configured to provide a relative frequency offset between a signal spectrum associated with the optical phase modulated signal and a transmission spectrum associated with the at least one optical filter.

34. A communications system for the communication of an optical phase modulated signal, said communications system comprising:
at least a first optical filter and a second optical filter;
a demodulator; and
a frequency offset means configured to provide a relative frequency offset between a signal spectrum associated with the optical phase modulated signal and a net transmission spectrum associated with the at least first optical filter and second optical filter.

35. A signal recovery method for an optical phase modulated signal, said optical phase modulated signal being passed along a communications system including at least one optical filter, the method comprising:
applying a relative frequency offset between a signal spectrum associated with the optical phase modulated signal and a transmission spectrum associated with the at least one optical filter; and
demodulating the optical phase modulated signal.

36. A signal recovery method according to claim 35, wherein the frequency bandwidth of the at least one optical filter is used to define a channel bandwidth of the communications system.

37. A signal recovery method according to claim 35, wherein the signal spectrum has a centre frequency associated with it and the transmission spectrum has a second centre frequency associated with it.

38. A signal recovery method according to claim 37, wherein the centre frequency of the signal spectrum defines a first offset origin and the centre frequency of the transmission spectrum is offset from the first offset origin.

39. A signal recovery method according to claim 37, wherein the centre frequency of the transmission spectrum defines a second offset origin and the centre frequency of the signal spectrum is offset from the second offset origin.

40. A signal recovery method according to claim 35, wherein the optical phase modulated signal is modulated with a modulation format employing phase shift keying.

41. A signal recovery method according to claim 40, wherein the magnitude of the relative frequency offset between the signal spectrum and the transmission spectrum is approximately between 40% to 60% of the frequency bandwidth of the at least one optical filter.

42. A signal recovery method according to claim 41, wherein the magnitude of the relative frequency offset between the signal spectrum and the transmission spectrum is approximately 50% of the frequency bandwidth of the at least one optical filter.

43. A signal recovery method according to claim 40, wherein the optical phase modulated signal is demodulated by combining the optical phase modulated signal with a local oscillator.

44. A signal recovery method according to claim 35, wherein the optical phase modulated signal is modulated with a modulation format employing Differential phase shift keying.

45. A signal recovery method according to claim 44, wherein the magnitude of the relative frequency offset between the signal spectrum and the transmission spectrum is approximately between 15% to 85% of the frequency bandwidth of the at least one optical filter.

46. A signal recovery method according to claim 44, wherein the optical phase modulated signal is demodulated by a differential demodulator having a destructive port and a constructive port so as to provide destructive fringes at the destructive port of and constructive fringes at the constructive port.

47. A signal recovery method according to claim 46, wherein the relative frequency offset is applied at the destructive port of the differential demodulator.

48. A signal recovery method according to claim 46, wherein the relative frequency offset is applied at the constructive port of the differential demodulator.

49. A signal recovery method according to claim 35, wherein the at least a first band pass filter and a second band pass filter are arranged in the communications system and the combination of the transmission spectrum of the first band pass filter and the transmission spectrum of the second band pass filter provides a net transmission spectrum having a net bandwidth which defines the channel bandwidth of the communications system.

50. A method for processing an optical phase modulated signal comprising:
passing the optical phase modulated signal along a communications system including at least one optical filter;
applying a relative frequency offset between a signal spectrum associated with the optical phase modulated signal and a transmission spectrum associated with the at least one optical filter; and
demodulating the optical phase modulated signal.

51. A method for processing an optical phase modulated signal comprising:
passing the optical phase modulated signal along a communications system including at least a first optical filter and second optical filter;
applying a relative frequency offset between a signal spectrum associated with the optical phase modulated signal and a net transmission spectrum associated with the at least first optical filter and second optical filter; and
demodulating the optical phase modulated signal.

52-55. (canceled)
